(19) United States
(12) Patent Application Publication
(10) Pub. No.: US 2007/0078673 A1
(43) Pub. Date: Apr. 5, 2007

(54) METHOD FOR EDITING TERM AND CONDITION ENTRIES OF A LEGAL DOCUMENT

(75) Inventors: Chung-I Lee, Tu-Cheng,Taipei Hsien (TW); Hai-Hong Lin, Shenzhen (CN); Xiao-Ping Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,212

(22) Filed: Jul. 13, 2006

(30) Foreign Application Priority Data
Aug. 26, 2005 (CN) 200510036846.1

(51) Int. Cl. G06Q 99/00; G06F 17/00

(52) U.S. Cl. 705/1; 715/530

(57) ABSTRACT

The present invention provides a method for editing term and condition entries of a legal document. The method includes the steps of: opening a legal document; integrating opinions on the term and condition entries of the legal document; editing the term and condition entries; determining whether any term and condition entry needs to be redefined according to the integrated opinions; redefining a new content for the term and condition entry if any term and condition entry needs to be redefined; sending the term and condition entry redefined to related users for reviewing; determining whether the term and condition entry redefined is approved; storing the term and condition entry redefined if the term and condition entry redefined is approved; and creating a finalized legal document.

### FIELD OF THE INVENTION

The present invention relates to a method for editing term and condition entries of a legal document.

### DESCRIPTION OF RELATED ART

Modern complex commercial relationships involve multiple business partners and processes. This complexity affects term and condition entries corresponding to business liabilities, which relates to costs, shipments, payments, qualities, volume breaks, rebate policies, discounts, and so forth. Managing all of these (particularly if you have hosts of ever-changing partnerships) requires a serious commitment of time and resources. Today, a typical enterprise is required to communicate with a variety of vendors, suppliers, service providers, and such by using contracts, protocols, or other types of legal documents.

Legal documents are used in almost all areas of commerce. Most conventional legal documents are reviewed, accepted, and signed using an inefficient, manually irritating process. This can seriously affect the efficiency of the businesses. In recent years, software programs on legal document management have been adopted into use. However, interfaces provided by the software programs are often text-based and accordingly cumbersome to use. Furthermore, the software programs also lack functionalities that allow legal document records to be efficiently reviewed, updated, and shared. The legal document records include significant events, discussions occurred during the negotiating process of individual contracts, and the completion and signing of finalized legal documents. The legal document records are generally stored in a database and accessed by a user through the interfaces each time the user needs to review it.

What is needed, therefore, is a method that can provide functions of editing term and condition entries of the legal documents efficiently.

### SUMMARY OF THE INVENTION

A method for editing term and condition entries of a legal document is provided. The method includes the steps of: opening a legal document; integrating opinions on the term and condition entries of the legal document; editing the term and condition entries; determining whether any term and condition entry needs to be redefined according to the integrated opinions; redefining a new content for the term and condition entry if any term and condition entry needs to be redefined; sending the term and condition entry redefined to related users for reviewing; determining whether the term and condition entry redefined is approved; storing the term and condition entry redefined if the term and condition entry redefined is approved; and creating a finalized legal document.

Furthermore, a method for editing term and condition entries of a legal document is provided. The method includes the steps of: establishing a legal document having blank content; inputting data into the legal document; incorporating a corresponding template into the legal document; creating a primary legal document based on the legal document; reflecting opinions on reviewing of the term and condition entries of the primary legal document; integrating the opinions; editing the term and condition entries; determining whether any term and condition entry needs to be redefined according to the integrated opinions; redefining new contents for the term and the condition entry if any term and condition entry needs to be redefined; sending the term and condition entry redefined to related users for further reviewing; determining whether the term and condition entry redefined is approved; storing the term and condition entry redefined if the term and condition entry redefined is approved; and creating a finalized legal document.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for editing term and condition entries of a legal document in accordance with a preferred embodiment;

FIG. 2 is a flowchart of a method for creating a primary legal document; and

FIG. 3 is a flowchart of a method for editing term and condition entries of a legal document in accordance with a preferred embodiment.

### DETAILED DESCRIPTION OF THE INVENTION

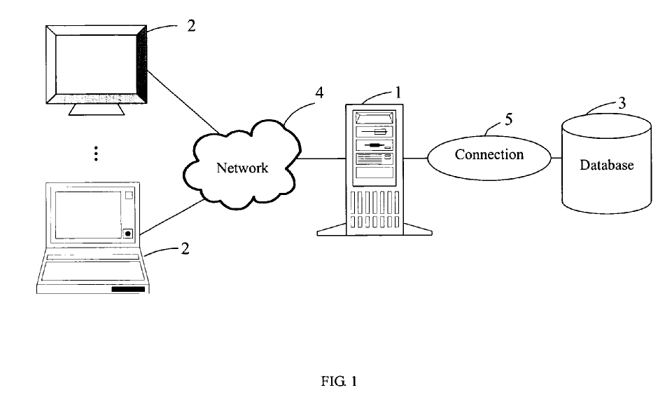

FIG. 1 is a schematic diagram of a hardware configuration of a system for editing term and condition entries of a legal document (hereinafter, “the system”) in accordance with a preferred embodiment. The system includes an application server 1, a plurality of clients 2 (only two shown), and a database 3. The application server 1 communicates with the clients 2 via a network 4. The network 4 may be an intranet, the Internet, or any other type of communication link. Each of the clients 2 is configured for providing an interactive interface enabling users to perform needed operations. For example, the users edit term and condition entries of the legal document by using the interactive interface. The legal document may be a contract, an agreement, terms of use, and so on. The users may belong to different departments, such as a purchasing department, a financial department, or a legal department in an enterprise or an affiliating member of a contracting party.

The application server 1 is configured for providing an administration interface to the users, and for editing term and condition entries in different types of legal documents.

The application server 1 is further connected with the database 3 via a connection 5. The database 3 is configured for storing different types of data, such as various templates, different types of legal documents, editions of term and condition entries, opinions, and so on. The connection 5 is a database connectivity, such as an open database connectivity (ODBC) or a Java database connectivity (JDBC).

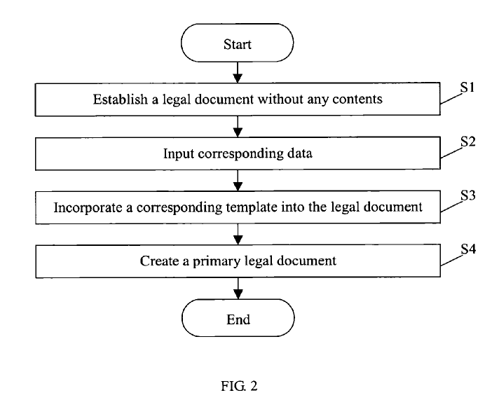

FIG. 2 is a flowchart of a method for creating a primary legal document. In step S1, the application server 1 establishes a legal document without any contents therein. In step S2, the application server 1 provides a guide for teaching the users how to input corresponding data and inserts the corresponding data inputted by the users into the legal document. The corresponding data includes information on the enterprise, the contracting party, a purchasing department related users, contact information of the related users, languages, auditing processes, a decision making power of a representative, and so on. The decision making power of the representative includes: strong power, medium power, and weak power. In respect to the decision making power of the representative, it is advantageous for the enterprise to negotiate with a proper corresponding representative to maximize profit.

In step S3, the application server 1 incorporates a template in the database 3 into the legal document according to the corresponding data. The database 3 stores a plurality of templates for different types of legal documents. The templates are classified by the application server 1 according to product types, contracting parties, or by other categories. Each template is an integrated legal document with predefined term and condition entries. Each term and condition entry has an attribute, such as an attribute that allows a plurality of options to be selected, an attribute that allows one option to be selected, and an attribute that forbids the term and condition entry to be modified etc. The previously-mentioned decision making power of the representative is also recorded in a remark column beside the each term and condition entry.

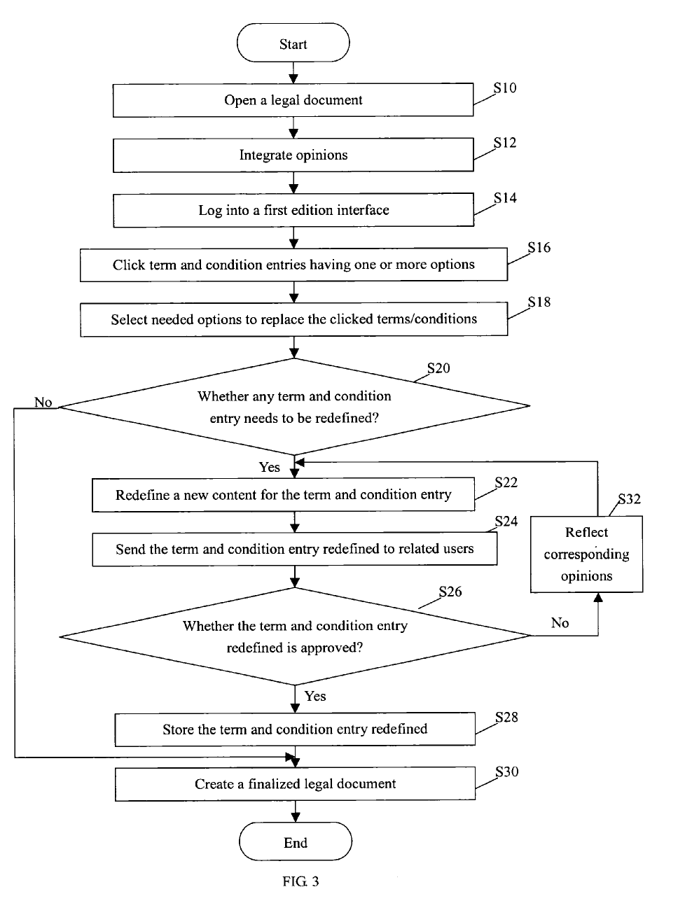

In step S4, the application server 1 creates a primary legal document based on the legal document, and sends the primary legal document to related users for reviewing. After reviewing, the related users reflect opinions through the interactive interfaces provided by the clients 2. The term and condition entries of the primary legal document stored in the database 3 can be edited according to a method for editing term and condition entries of a legal document (described in detail below in relation to FIG. 3).

FIG. 3 is a flowchart of a method for editing term and condition entries of a legal document. In step S10, the user logs into the administration interface provided by the application server 1 and opens the legal document that needs to be edited, such as the primary legal document. In step S12, the application server 1 integrates the opinions reflected by the users.

In step S14, the user logs into a first edition interface provided by the application server 1, and audits the term and condition entries of the legal document. In the first edition interface, the term and condition entries are highlighted with different colors according to different attributes of the term and condition entries. For example, application server 1 highlights the term and condition entries that allow a plurality of options to be selected with blue fonts, highlights the term and condition entries that allow only one option to be selected with red fonts, or highlights the term and condition entries that forbid the term and condition entries to be modified with black fonts.

In step S16, the application server 1 displays all options corresponding to each term and condition entry, and displays the decisions making power of the representative corresponding to the options. For example, the application server 1 displays the term and condition entry having the decision making power of the corresponding representative remarked as “strong power”; the user clicks the term and condition entry through with a mouse selection, the application server 1 then displays all the options of the clicked term and condition entry; displaying the decisions making power of the representative corresponding to the options: “medium power” and “weak power”. For another example, if the clicked term and condition entry refers to a date or a number, the options of the clicked term and condition entry includes other defined dates or numbers selectable by the user.

In step S18, the user selects needed options to replace the clicked term and condition entries according to integrated opinions. The decisions making power of the representative beside the clicked term and condition entries are also updated according to the selected options.

In step S20, the application server 1 determines whether any term and condition entry needs to be redefined according to the integrated opinions. If any term and condition entry needs to be redefined, in step S22, the user logs into an advanced edition interface and redefines a new content for the term and condition entry using a pop-up dialog box according to the integrated opinions as a term and condition entry redefined. In the advanced edition interface, all the term and condition entry can be completely redefined by the user. Otherwise, if no term and condition entries need to be redefined, the procedure goes directly to step S30.

In step S24, the application server 1 sends the term and condition entry redefined to the related users for further reviewing, such as users from the legal department in the enterprise etc. In step 26, the application server 1 determines whether the related users approve the term and condition entry redefined. If the term and condition entry redefined is approved, in step S28, the database 3 stores the term and condition entry redefined. Otherwise, if the term and condition entry redefined is not approved, in step S32, the related users reflect corresponding opinions on the term and condition entry redefined, and the procedure returns to step S22 to redefine the term and condition entry again.

In step S30, the application server 1 creates a finalized legal document after storing the term and condition entry redefined that is approved. The finalized legal document is ready to be confirmed and signed by corresponding managers of the enterprise and the contracting party.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A method for editing term and condition entries of a legal document, the method comprising the steps of:
opening a legal document;
integrating opinions on the term and condition entries of the legal document;
editing the term and condition entries;
determining whether any term and condition entry needs to be redefined according to the integrated opinions;
redefining a new content for the term and condition entry if any term and condition entry needs to be redefined;
sending the term and condition entry redefined to related users for reviewing;
determining whether the term and condition entry redefined is approved;
storing the term and condition entry redefined if the term and condition entry redefined is approved; and
creating a finalized legal document.

2. The method according to claim 1, further comprising the step of:
reflecting corresponding opinions if the term and condition entry redefined is not approved; and
sending the opinions on term and condition entry redefined that is not approved.

3. The method according to claim 1, further comprising the steps of:
creating the finalized legal document if no term and condition entries need to be redefined.

4. The method according to claim 1, wherein the editing step further comprises the steps of:
logging into a first edition interface;
clicking term and condition entries having options; and
selecting the options to replace the clicked term and condition entries.

5. The method according to claim 4, wherein the term and condition entries in the first edition interface comprise different types of attributes, the attributes comprising:
an attribute that allows a plurality of options to be selected;
an attribute of that allows only one option to be selected; and
an attribute that forbids the term and condition entry to be modified.

6. The system as claimed in claim 5, wherein the term and condition entries are highlighted with different colors according to the attributes of the term and condition entries.

7. A method for editing term and condition entries of a legal document, the method comprising the steps of:
establishing a legal document having blank content;
inputting data into the legal document;
incorporating a corresponding template into the legal document;
creating a primary legal document based on the legal document;
reflecting opinions on reviewing of the term and condition entries of the primary legal document;
integrating the opinions;
editing the term and condition entries;
determining whether any term and condition entry needs to be redefined according to the integrated opinions;
redefining new contents for the term and the condition entry if any term and condition entry needs to be redefined;
sending the term and condition entry redefined to related users for further reviewing;
determining whether the term and condition entry redefined is approved;
storing the term and condition entry redefined if the term and condition entry redefined is approved; and
creating a finalized legal document.

8. The method according to claim 7, further comprising the steps of:
creating the finalized legal document if no term and condition entries need to be redefined.

9. The method according to claim 7, wherein the editing step further comprises the steps of:
logging into a first edition interface;
clicking the term and condition entries having options; and
selecting the options to replace the clicked term and condition entries.
